(19) United States
(12) Patent Application Publication
(10) Pub. No.: US 2010/0085154 A1
(43) Pub. Date: Apr. 8, 2010

(54) METHOD AND DEVICE OF FORMING RFID VIRTUAL TAG AND METHOD FOR RECEIVING CONTENTS USING THE SAME

(75) Inventors: Nam Je PARK, Jinju-si (KR); Doo Ho CHOI, Cheonan-si (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunication Research Institute, Daejeon (KR)

(21) Appl. No.: 12/566,336

(22) Filed: Sep. 24, 2009

(30) Foreign Application Priority Data
Oct. 6, 2008 (KR) 10-2008-0097765

(51) Int. Cl. G06F 7/04; G06K 9/00

(52) U.S. Cl. 340/5.85; 382/100; 382/176

(57) ABSTRACT

Provided is a radio frequency identification (RFID) tag generating method and device, and a contents receiving method using the same. The contents receiving method using the RFID tag generating device includes: a terminal detecting a virtual tag corresponding to contents; receiving a password to be used once, corresponding to the virtual tag; authenticating a user by determining whether the password to be used once corresponds to a password input by the user; receiving an identification code of the virtual tag when the password to be used once corresponds to a password input by the user; and receiving the contents matching the identification code of the virtual tag, and providing the same to the user.

### CROSS-REFERENCE TO RELATED APPLICATION

This application claims priority to and the benefit of Korean Patent Application No. 10-2008-0097765 filed in the Korean Intellectual Property Office on Oct. 6, 2008, the entire contents of which are incorporated herein by reference.

### BACKGROUND OF THE INVENTION

(a) Field of the Invention

The present invention relates to radio frequency identification (RFID) tag generating method and device, and a contents receiving method using the same. Particularly, the present invention relates to an RFID tag generating method and device using an RFID virtual tag based on a mobile radio frequency identification terminal platform in the portable terminal condition, and a contents receiving method using the same.

(b) Description of the Related Art

RFID represents an automatic identification technique for freely identifying and recording tag information attached on a target substance without directly contacting the substance by using a radio communication technique, and it includes a tag, an antenna, a reader, middleware, and an application service platform.

Regarding mobile RFID, a portable terminal including an RFID reader transmits information corresponding to a recognized RFID tag to a user through a mobile communication network (e.g., CDMA or HSDPA).

The current mobile RFID provides a one-to-one service between a passive RFID tag and an RFID reader. An RFID tag is classified as an active tag and a passive tag according to a battery-installed state in the tag. Also, the RFID tag stores various information on goods or target products, and it is attached to the goods or target products in a like manner to barcodes. Information installed in the RFID tag is sensed by the RFID reader, and it is used to identify the goods or acquire information on the goods.

Accordingly, the conventional RFID tag attached goods or target products generate an installation cost caused by attachment of the RFID tag. Also, when the attached RFID tag is lost, a new RFID tag must be attached, and hence its maintenance is not easy.

Further, since the information built in the RFID tag can be used at the time when or point where the RFID tag is attached, usage of information on the RFID tag is temporally or spatially restricted.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an RFID virtual tag generating method and device for generating an RFID virtual tag assigned to contents through image media, and providing various information to the user by using the RFID virtual tag, and a contents receiving method using the same.

An exemplary embodiment of the present invention provides a method for receiving contents including: a terminal detecting a virtual tag corresponding to contents; receiving a password to be used once corresponding to the virtual tag; authenticating a user by determining whether the password to be used once corresponds to a password input by the user; receiving an identification code of the virtual tag when the password to be used once corresponds to a password input by the user; and receiving the contents matching the identification code of the virtual tag, and providing the same to the user.

Another embodiment of the present invention provides a device for generating an RFID virtual tag including: a generating module for generating a virtual tag corresponding to contents that are externally output; a password module for generating a virtual tag password to be used once, and transmitting the password to a terminal to authenticate the terminal's user; and a control module for assigning an identification code to the virtual tag, and transmitting the identification code to the terminal after authentication.

Yet another embodiment of the present invention provides a method for generating an RFID virtual tag including: receiving contents from a server; generating a virtual tag corresponding to the contents; generating a password to be used once when a user's terminal detects the virtual tag; controlling user authentication by transmitting the password to the terminal; and transmitting an identification code of the virtual tag to the terminal when receiving an authentication finish message from the terminal.

### BRIEF DESCRIPTION OF THE DRAWINGS

FIG. 1 shows a condition for generating an RFID virtual tag according to an exemplary embodiment of the present invention.

FIG. 2 shows a configuration of an RFID virtual tag generating device and an image editing application server of FIG. 1.

FIG. 3 shows a configuration of a control module of an RFID virtual tag generating device of FIG. 2.

FIG. 4 shows a flowchart of a method for receiving contents by using an RFID virtual tag generating device according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, a terminal may indicate a mobile station (MS), a mobile terminal (MT), a subscriber station (SS), a portable subscriber station (PSS), user equipment (UE), and an access terminal (AT), and it may include entire or partial functions of the mobile station, the mobile terminal, the subscriber station, the portable subscriber station, the user equipment, and the access terminal.

Hereinafter, an RFID virtual tag generating method and device and a contents receiving method according to an exemplary embodiment of the present invention will be described with reference to accompanying drawings.

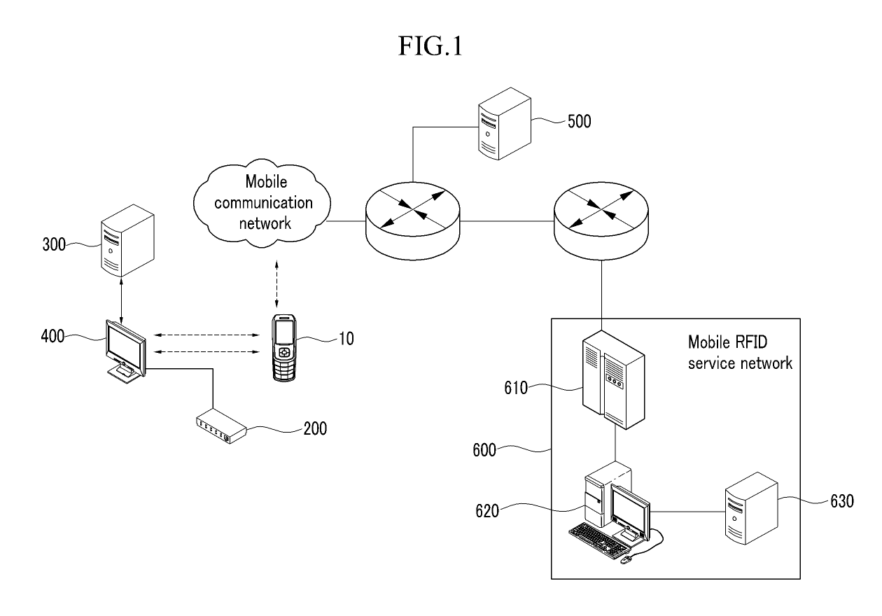

FIG. 1 shows a condition for generating an RFID virtual tag according to an exemplary embodiment of the present invention.

As shown in FIG. 1, in order to generate an RFID virtual tag according to an exemplary embodiment of the present invention, a terminal 10 including an RFID reader 100, an RFID virtual tag generating device 200, an image editing application server 300, an image media device 400, an object directory service (ODS) server 500, and a mobile RFID service network (SMAP) 600 are provided.

The terminal 10 includes the RFID reader 100, and it receives a plurality of contents (e.g., movies, games, and advertisements) from the mobile RFID service network 600 through the RFID reader 100 and provides the contents to a user in real-time.

When sensing an RFID virtual tag, the RFID reader 100 requests information on the RFID virtual tag, and receives an identification code of the RFID virtual tag. Here, the RFID virtual tag is included in the contents output by the image media device 400, and it is generated by the RFID virtual tag generating device 200. For example, the RFID virtual tag can be a tag corresponding to predetermined substance included in an advertisement scene among the contents output by the image media device 400.

In the case of requesting information on the RFID virtual tag, the reader 100 performs a user authentication process between the RFID virtual tag generating device 200 and the terminal 10 through a one-time password (OTP) authentication method.

After the user authentication process, the RFID reader 100 transmits the identification code provided by the RFID virtual tag generating device 200 to the ODS server 500, and receives contents corresponding to the identification code, for example location information on an object information server (OIS) server including an advertisement scene from the ODS server 500. For example, the RFID reader 100 receives location information on the OIS server including the advertisement scene, accesses the corresponding OIS server 620 based on the location information, and receives contents.

The RFID virtual tag generating device 200 generates an RFID virtual tag corresponding to the contents output by the image media device 400, and transmits an RFID virtual tag signal to the RFID reader 100. Also, the RFID virtual tag generating device 200 generates an identification code corresponding to the RFID virtual tag and manages the RFID virtual tag. The RFID virtual tag generating device 200 transmits an identification code of a predetermined RFID tag to the RFID reader 100 according to an additional request.

The RFID virtual tag generating device 200 receives a detection signal for notifying detection of the RFID virtual tag from the RFID reader 100, and generates an OTP corresponding to the RFID virtual tag when the RFID reader 100 requests information on the RFID virtual tag.

The RFID virtual tag generating device 200 includes an active RFID virtual tag generating device including a battery (not shown).

The image editing application server 300 manages RFID virtual tag history information by combining a management technique for managing the generated RFID virtual tag and an editing technique for editing an image caption. Also, the image editing application server 300 is described to be separated from the RFID virtual tag generating device 200.

The image media device 400 outputs contents, and it includes an automated teller machine, a kiosk, and a vending machine. Here, the output contents include a TV commercial, a subway advertisement, a bus advertisement, a street advertisement, emergency information, and mobile shopping information.

The ODS server 500 stores location information (for example, a uniform resource locator (URL)) of the mobile information service server 620 for providing contents information corresponding to the detection signal received from a mobile RFID service gateway (MBDG) 510. Hereinafter, the location information will be called “URL information”.

Also, the ODS server 500 transmits the generated URL information to the mobile RFID service network 600 to transmit the contents to the terminal 10 from a corresponding mobile information service server 620.

The mobile RFID service network 600 includes a mobile RFID service gateway (MBDG) 610, an object information (OIS) server 620, and an RFID user privacy management service (RPS) server 630.

The MBDG 610 receives a detection signal transmitted when the RFID virtual tag is detected and an information request signal including user information stored in the terminal from the terminal 10 including the RFID reader 100, checks a communication service provider included in the information request signal, and transmits the detection signal and the information on the checked communication service provider to the ODS server 500.

The OIS server 620 includes contents matching the identification code of the RFID virtual tag, and shares the contents output by the image media device 400. Here, the contents include image information including advertisements, movies, and dramas. For example, the OIS server 620 includes an advertisement scene corresponding to the identification code of the RFID virtual tag.

The RPS server 630 sets the security level for protecting the user's privacy, processes advertisement applications, and controls the access right to product information.

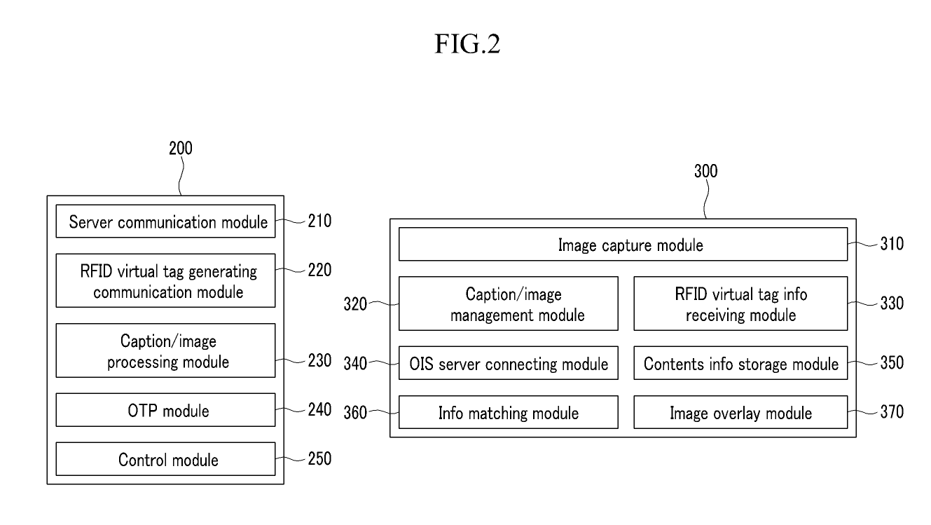

An RFID virtual tag generating device 200 and an image editing application server 300 for managing history information on the generated RFID virtual tag according to an exemplary embodiment of the present invention will now be described in detail with reference to FIG. 2.

FIG. 2 shows a configuration of an RFID virtual tag generating device and an image editing application server of FIG. 1.

The RFID virtual tag generating device 200 includes a server communication module 210, an RFID virtual tag generating communication module 220, a caption/image processing module 230, an image advertisement processing module 240, and a control module 250.

The server communication module 210 receives the contents in linkage with the ODS server 500 and the mobile RFID service network 600.

The RFID virtual tag generating communication module 220 receives the contents output by the image media device 400 through the control module 250, and generates an RFID virtual tag corresponding to the contents.

The caption/image processing module 230 generates an RFID virtual tag corresponding to the caption and the image managed by the image editing application server 300 among the contents output by the image media device 400.

The OTP module 240 generates an OTP and transmits the OTP to the RFID reader 100 when the RFID reader 100 requests information on the RFID virtual tag to thus perform an authentication process between the RFID virtual tag generating device 200 and the user of the terminal 10 including the RFID reader 100.

The control module 250 receives the contents output by the image media device 400, and transmits the identification code of the RFID virtual tag corresponding to the received contents to the terminal 10.

The image editing application server 300 includes an image capture module 310, a caption/image management module 320, an RFID virtual tag information receiving module 330, an OIS server connecting module 340, a contents information storage module 350, an information matching module 360, and an image overlay module 370.

The image capture module 310 captures the contents output by the image media device 400 per screen.

The caption/image management module 320 divides the information on the captured screen into caption and image information, manages them, and transmits the caption and image information to the RFID virtual tag generating device 200.

The RFID virtual tag information receiving module 330 receives the RFID virtual tag corresponding to the caption and image information transmitted by the caption/image management module 320 from the RFID virtual tag generating device 200.

The OIS server connecting module 340 receives the identification code of the RFID virtual tag from the control module 250, and receives the contents matching the identification code from the OIS server 620.

The contents information storage module 350 stores information of the received contents through the OIS server connecting module 340.

The information matching module 360 matches the identification code of the RFID virtual tag, and matches the respective identification codes and the received contents.

The image overlay module 370 controls to output the contents including the RFID virtual tag by overlaying the received RFID virtual tag on the contents output through the image media device 400.

A control module 250 of an RFID virtual tag generating device according to an exemplary embodiment of the present invention will now be described with reference to FIG. 2.

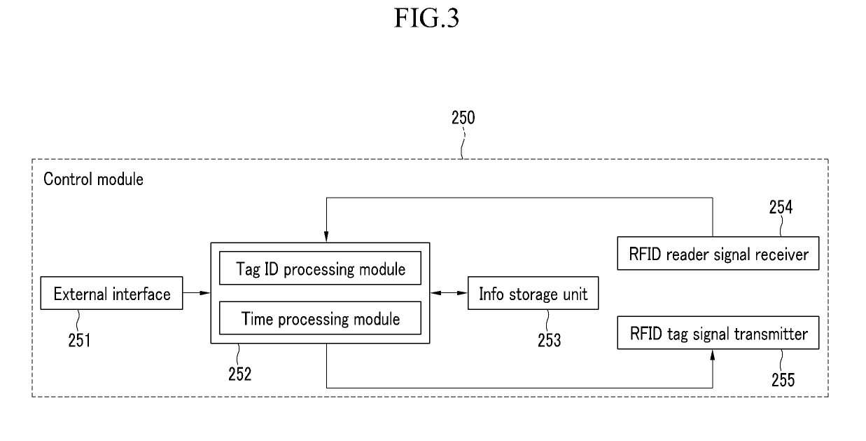

FIG. 3 shows a configuration of a control module of an RFID virtual tag generating device of FIG. 2.

As shown in FIG. 3, the control module 250 includes a media interface 251, a controller 252, an information storage unit 253, an RFID reader signal receiver 254, and an RFID virtual tag signal transmitter 255.

First, the media interface 251 receives the contents output by the image media device 400 in linkage with the external image media device 400.

The controller 252 includes a tag ID processing module 252a and a time processing module 252b.

The tag ID processing module 252a assigns an identification code corresponding to the generated RFID virtual tag. For example, the RFID virtual tag generating communication module 220 assigns an identification code to the RFID virtual tag corresponding to one advertisement scene among the contents output by the image media device 400.

The time processing module 252b records the time when the image is output by the image media device 400 and the time when a tag detection signal is received from an external device.

The information storage unit 253 stores the identification code and the time information respectively generated by the tag ID processing module 252a and the time processing module 252b.

When the RFID reader 100 detects an RFID virtual tag, the RFID reader signal receiver 254 receives a detection signal from the RFID reader 100, and receives a signal for requesting information on the RFID virtual tag corresponding to the detection signal.

The RFID virtual tag signal transmitter 255 transmits the generated RFID virtual tag signal to the RFID reader 100 in real time. In this instance, the RFID virtual tag signal transmitter 255 links the RFID virtual tag signal with the contents including the virtual tag, that is, the contents output by the image media device 400, and then transmits the same.

Also, the RFID virtual tag signal transmitter 255 transmits an identification code corresponding to a signal for requesting information received from the RFID reader 100 to the RFID reader 100.

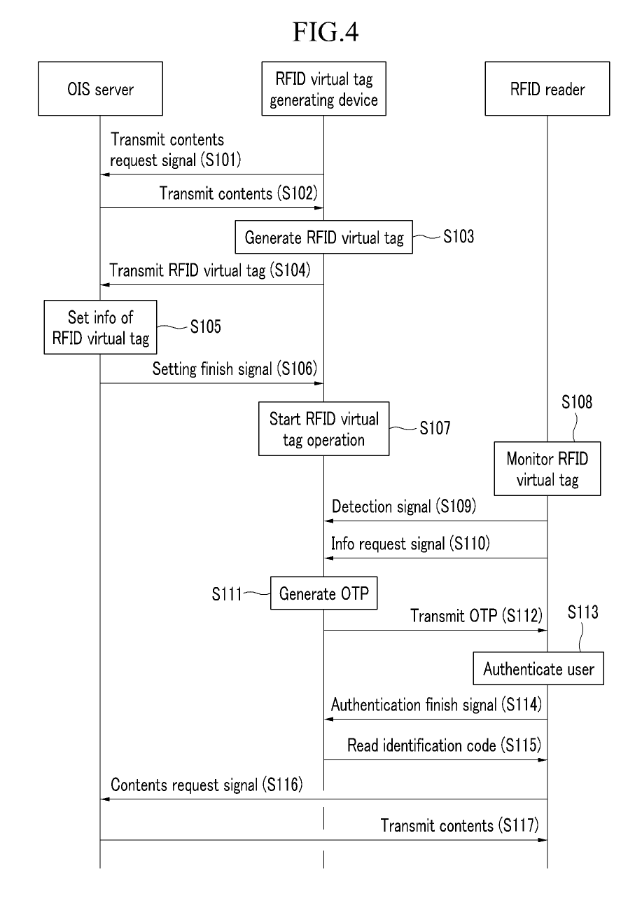

A method for controlling an RFID virtual tag according to an exemplary embodiment of the present invention will now be described with reference to FIG. 4.

FIG. 4 shows a flowchart of a method for receiving contents by using an RFID virtual tag generating device according to an exemplary embodiment of the present invention.

As shown in FIG. 4, the RFID virtual tag generating device 200 requests the contents output by the image media device 400 from the OIS server 620 (S101). The OIS server 620 transmits the contents corresponding to the request signal to the RFID virtual tag generating device 200 (S102).

The RFID virtual tag generating device 200 generates an RFID virtual tag corresponding to the received contents (S103). Also, the RFID virtual tag generating device 200 assigns an identification code corresponding to the RFID virtual tag. For example, an RFID virtual tag is generated to the advertisement scene among the contents, and an identification code is assigned to the generated RFID virtual tag.

The RFID virtual tag generating device 200 transmits the generated RFID virtual tag to the OIS server 620. The OIS server 620 sets information of the contents so as to be matched with information on the received RFID virtual tag, that is, the identification code (S105). The OIS server 620 transmits a setting finish signal to the RFID virtual tag generating device 200 to report that information of the RFID virtual tag is set (S106). Also, the RFID virtual tag generating device 200 starts an operation of the RFID virtual tag (S107). In this instance, the RFID virtual tag generating device 200 transmits the signal of the RFID virtual tag to the terminal so that the terminal may detect the RFID virtual tag.

The RFID reader 100 included in the terminal 10 possessed by the user detects the RFID virtual tag included in the contents (S108). In detail, the RFID reader 100 receives the RFID virtual tag signal corresponding to the virtual tag corresponding to the output contents from the RFID virtual tag generating device 200 having generated the virtual tag, and detects the RFID virtual tag.

The RFID reader 100 transmits the detection signal to the RFID virtual tag generating device 200 to notify that the RFID virtual tag is detected (S109).

Also, the RFID reader 100 having detected the RFID virtual tag transmits the information request signal to the RFID virtual tag generating device 200 to request information on the detected RFID virtual tag (S110).

When the RFID reader 100 requests information of the RFID virtual tag, the RFID virtual tag generating device 200 generates an OTP corresponding to the RFID virtual tag (S111). The RFID virtual tag generating device 200 transmits the generated OTP to the RFID reader 100 (S112).

When receiving the OTP, the RFID reader 100 determines whether a password input by the user matches the OTP, and authenticates the user (S113). Here, the password input by the user can be received through a keypad or a microphone of the terminal. That is, the user recognizes the password to be currently used through an additional OTP card (not shown), and directly inputs the password by using the keypad or directly speaks the password through the microphone to thus input it. Here, the OTP represents the password of the RFID virtual tag that is used only once, and it is a password for authenticating the user of the terminal 10. The mobile OTP (MOTP) used by the terminal can be generated by a once-used password generating software program to be installed in the terminal.

When the OTP corresponds to the user's password, the RFID reader 100 determines that the corresponding user is a legal user, transmits an authentication finish signal to the RFID virtual tag generating device 200, and notifies that the user authentication is finished (S114). In addition, when OTP does not correspond to the user's password, the RFID reader 100 stops the process of providing the contents to the user.

The RFID reader 100 reads the identified identification code through information on the RFID virtual tag having received the finish of user authentication (S115). Further, the RFID reader 100 receives URL information of the contents server corresponding to the read identification code from the ODS server 500.

The RFID reader 100 transmits a contents request signal to the corresponding OIS server 620 based on the received URL information to request the contents matching the identification code of the RFID virtual tag (S116). The OIS server 620 transmits the contents matching the identification code to the RFID reader 100 to provide the contents to the user of the terminal including the RFID reader 100 (S117).

Accordingly, the RFID virtual tag generating device and method according to the exemplary embodiment of the present invention can easily use the corresponding contents or support the contents any time and any place through the access of the OIS server by using the RFID virtual tag corresponding to the output contents.

Further, convenience of information application can be provided to the user without any temporal or spatial limits through real-time acquisition of contents corresponding to the RFID virtual tag.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a terminal to receive contents comprising:
detecting a virtual tag corresponding to contents;
receiving a password to be used once corresponding to the virtual tag;
authenticating a user by determining whether the password to be used once corresponds to a password input by the user;
receiving an identification code of the virtual tag when the password to be used once corresponds to a password input by the user; and
receiving the contents matching the identification code of the virtual tag, and providing the same to the user.

2. The method of claim 1, wherein
the virtual tag is included in the contents that are output through an external image media, and
the detecting includes
receiving a signal corresponding to the virtual tag corresponding to the output contents from a device having generated the virtual tag, and detecting the virtual tag.

3. The method of claim 1, wherein
the receiving of an identification code includes:
receiving location information of a server including the contents corresponding to the identification code; and
receiving the contents matching the identification code from a contents server corresponding to the location information.

4. The method of claim 1, wherein
the performing of authentication includes
stopping the authentication process when the password to be used once does not correspond to a password input by the user

5. A device for generating an RFID virtual tag comprising:
a generating module for generating a virtual tag corresponding to contents that are externally output;
a password module for generating a virtual tag password to be used once, and transmitting the password to a terminal to authenticate the terminal's user; and
a control module for assigning an identification code to the virtual tag, and transmitting the identification code to the terminal after authentication.

6. The device of claim 5, wherein
the control module includes:
a processing module for assigning an identification code corresponding to the virtual tag;
a signal transmitter for transmitting a signal of the virtual tag to the terminal; and
a signal receiver for receiving a detection signal for detecting the virtual tag from the terminal.

7. The device of claim 5, wherein
the device is operable in linkage with an image editing server for managing history information of the virtual tag by editing the image and the caption included by a screen among the contents.

8. The device of claim 7, wherein
the image editing server includes:
a server connecting module for receiving contents from an external server;
a capture module for capturing the received contents per screen;
a tag information receiving module for dividing information on the captures screen into image and caption information, and receiving a virtual tag corresponding to the divided image and caption; and
an overlay module for including the virtual tag in the received contents.

9. The device of claim 8, wherein
the server connecting module transmits the contents including the virtual tag to the external server.

10. A method for generating an RFID virtual tag, comprising:
receiving contents from a server;
generating a virtual tag corresponding to the contents;
generating a password to be used once when a user's terminal detects the virtual tag;
controlling user authentication by transmitting the password to the terminal; and
transmitting an identification code of the virtual tag to the terminal when receiving an authentication finish signal from the terminal.

11. The method of claim 10, wherein
the generating of a virtual tag includes:
capturing the received contents per screen;
dividing information of the captured screen into image and caption information, and generating a virtual tag corresponding to the divided image and caption;
generating overlaid contents by including the virtual tag in the received contents; and
assigning an identification code to the generated virtual tag.

12. The method of claim 11, further including
transmitting the overlaid contents and the assigned identification code to an external server.

13. The method of claim 11, further including
transmitting a signal corresponding to the virtual tag to the user's terminal so that the terminal may detect the virtual tag.

14. The method of claim 10, wherein
the transmitting of an identification code of the virtual tag to the terminal includes:
providing the identification code to the terminal when receiving an authentication success signal from the terminal; and
stopping the user authentication process when receiving an authentication failure signal from the terminal.
